(19) United States
(12) Patent Application Publication
(10) Pub. No.: US 2010/0027121 A1
(43) Pub. Date: Feb. 4, 2010

(54) LENS AND METHOD FOR MANUFACTURING THE SAME

(75) Inventors: Norihisa Takahara, Osaka (JP); Takashi Ohta, Osaka (JP); Yuka Okada, Hyogo (JP); Akiko Murata, Osaka (JP)

Correspondence Address: HAMRE, SCHUMANN, MUELLER & LARSON P.C., P.O. BOX 2902-0902, MINNEAPOLIS, MN, 55402, US

(73) Assignee: PANASONIC CORPORATION, Kadoma-shi, Osaka (JP)

(21) Appl. No.: 12/516,039

(22) PCT Filed: Dec. 11, 2007
(86) PCT No.: PCT/JP2007/073874

§ 371 Date: May 22, 2009

(30) Foreign Application Priority Data
Dec. 14, 2006 (JP) 2006-336819

(51) Int. Cl. G02B 5/18; B05D 5/06; G02B 3/00; G02B 1/10; G02B 3/08

(52) U.S. Cl. 359/570; 427/162; 359/642; 359/619

(57) ABSTRACT

A lens according to the present invention includes at least one first area (11) including a lens portion (11a) with a convex shape, and a second area (12) surrounding the first area (11). A groove (13) surrounding the first area (11) is formed between the first area (11) and the second area (12). A coating layer (14) is formed on the lens portion (11a).

### TECHNICAL FIELD

The present invention relates to a lens including a coating layer, and a method for manufacturing the same.

### BACKGROUND ART

Coating layers can be formed on the surface of a lens, such as contact lens, camera lens, and optical pickup for CD (Compact Disc) and DVD (Digital Versatile Disc), for various purposes. Examples of coating layers include an antireflective film for preventing light reflection on the surface of lens, a hard coat film for protecting the surface of lens from damage, and a refractive index matching film for correcting chromatic aberration in lens base.

When the thickness variation in a coating layer has a significant influence on lens performance, it is necessary to make the thicknesses of the coating layer uniform. Molding can be used as a method for forming a coating layer with a uniform thickness. In molding, a lens base is placed in a mold, and the material for the coating layer is cast between the lens base and the mold. Then, the material of the coating layer is cured. After that, the lens is removed from the mold. In this method, the shape of the coating layer is defined by the mold, so that a coating layer with a uniform thickness can be formed. However, there has been a problem that many molds, which are expensive, are needed in mass production using molding, resulting in high production cost.

In an effort to solve such a problem, there is disclosed a method for forming a coating layer using spin coating (see e.g. JP2002-263553A, JP2003-149423A, JP2003-154304A). In spin coating, the material of the coating layer is dropped on a plane base, and subsequently, the base is rotated, so that the material is applied across the base.

However, when forming the coating layers of lens using spin coating, the shape of the lens needs to be in such a shape that the material of the coating layer smoothly spreads over a curved lens surface. Therefore, when using spin coating, the shape of the peripheral portion of the curved lens surface should be different from a desired shape of the curved lens surface by necessity. As a result, there has been a problem that the peripheral portion of the lens does not serve as a lens sufficiently.

In addition, there is disclosed a method for forming a coating layer using a dipping method (see e.g. JP2002-107502A). In this method, a coating layer is formed entirely on the surface of a lens base. However, if a coating layer is formed in areas other than the lens portion, the optical axis may shift in the course of mounting the lens to a device.

### DISCLOSURE OF THE INVENTION

In such a situation, it is an object of the present invention to provide a lens including a coating layer with a uniform thickness and ensuring accurate mounting, and a method for manufacturing the same.

To achieve the above-described object, the lens according to the present invention including at least one first area having a lens portion with a convex shape, and a second area surrounding the first area, wherein a groove surrounding the first area is formed between the first and the second area, and a coating layer is formed on the lens portion.

Further, a method for manufacturing a lens including a lens portion with a convex shape and a coating layer formed on the lens portion according to the present invention, includes the steps of (i) providing a lens base including at least one first area having the lens portion, and a second area surrounding the first area, (ii) placing the material of the coating layer on the lens portion, wherein a groove surrounding the first area is formed between the first area and the second area in the lens base.

According to the present invention, a coating layer with a uniform thickness can be formed on the lens portion. Further, in the present invention, unlike conventional methods, it is not required that the shape of the peripheral portion of the lens be in such a shape that the material of the coating layer smoothly spreads over the surface of the lens. Therefore, according to the present invention, the whole of the lens portion can serve effectively as a lens. Furthermore, according to the present invention, it is possible to prevent formation of a coating layer on the second area that surrounds the lens portion. Therefore, the lens can be mounted accurately on a device using the second area as a reference surface.

### BRIEF DESCRIPTION OF THE DRAWINGS

FIG. 1A is a top view illustrating an example of a lens according to the present invention, FIG. 1B is a cross sectional view thereof, and FIG. 1C is a top view illustrating a lens base used for the lens shown in FIG. 1A.

FIGS. 2A to 2C are process views illustrating an example of a method for forming a coating layer using spin coating.

FIGS. 3A to 3D are process views illustrating an example of a method for forming a coating layer using screen printing.

FIGS. 4A to 4D are process views illustrating an example of a method for forming a coating layer using pad printing.

FIG. 5A is a top view illustrating another example of a lens according to the present invention, FIG. 5B is a cross sectional view thereof, and FIG. 5C is a top view illustrating a lens base used for the lens shown in FIG. 5A.

FIG. 6A is a top view illustrating another example of a lens according to the present invention, and FIG. 6B is a cross sectional view thereof.

FIG. 7A is a top view illustrating a lens of Comparative Example 1, and FIG. 7B is a cross sectional view thereof.

FIG. 8 is a view illustrating a method for measuring the thickness of a coating layer.

FIG. 9 is a graph showing a measurement result of the thickness of a coating layer with respect to the lens of Example 1 and the lens of Comparative Example 1.

FIG. 10 is a graph showing a measurement result of the thickness of a coating layer with respect to the lens of Example 2 and the lens of Comparative Example 2.

FIG. 11A is a top view illustrating a lens of Comparative Example 3, and FIG. 11B is a cross sectional view thereof.

FIG. 12 is a view illustrating a method for measuring the thickness of a coating layer.

FIG. 13 is a graph showing a measurement result of the thickness of a coating layer with respect to the lens of Example 3 and the lens of Comparative Example 3.

FIG. 14 is a graph showing a measurement result of the thickness of a coating layer with respect to the lens of Example 4 and the lens of Comparative Example 4.

FIG. 15 is a graph showing a measurement result of the thickness of a coating layer with respect to the lenses of Example 5.

FIG. 16 is a graph showing a measurement result of the thickness of a coating layer with respect to the lenses of Comparative Example 5.

FIG. 17A is a top view illustrating a lens base of Example 6, and FIG. 17B is a cross sectional view thereof.

FIG. 18 is a graph showing a measurement result of the thickness of a coating layer with respect to the lenses of Example 6.

FIG. 19 is a graph showing a measurement result of the thickness of a coating layer with respect to the lenses of Comparative Example 6.

FIG. 20 is a graph showing a measurement result of the thickness of a coating layer with respect to the lens of Example 7 and the lens of Comparative Example 7.

FIG. 21 is a graph showing a measurement result of the thickness of a coating layer with respect to the lens of Example 8 and the lens of Comparative Example 8.

### BEST MODE FOR CARRYING OUT THE INVENTION

Hereinafter, embodiments of the present invention are described by way of example. The present invention is not limited to the following embodiments. In the following description, although there may be a case where a specific numeric value or a specific material is indicated as an example, other numeric values or other materials may be applied, as long as the advantages of the present invention can be obtained.

### [Lens]

The lens used in the present invention includes at least one first area having a lens portion with a convex shape and a second area surrounding the first area. A groove surrounding the first area is formed between the first area and the second area. A coating layer is formed on the lens portion. Hereinafter, a member including the first and second areas may be referred to as a “lens base”.

The material of the lens base has no limitation, as long as it is capable of forming a groove and a lens portion that serves as a lens. Glass or transparent optical polymer may be used as a material of the lens base.

The first area each includes a lens portion with a convex shape. There is no limitation in the size of the lens portion. In an example, the lens portion may be in the range of 1 mm to 10 mm in diameter. The shape of the lens is specified depending on the intended use. The shape of the lens may be spherical or aspherical. The lens portion may be a diffractive lens. A typical diffractive lens has a shape in which a plurality of cylindrical columns each having a different diameter are stacked in layers so that the diameter becomes smaller toward the top. Such a shape may be referred to as a “blazed grating”.

A coating layer is formed on the surface of the lens portion. The type of the coating layer to be formed may be selected depending on the intended use. The coating layer may be an antireflective film, a hard coat protective film, or a refractive index matching film. An antireflective film prevents light reflection on the surface of lens. A hard coat protective film protects the surface of lens from damage. A refractive index matching film corrects chromatic aberration. The coating layer may be a single-layer, or may be a multi-layer.

The material of the coating layer is selected depending on the intended use of the coating layer and forming method thereof. The material of the coating layer may be, for example, a transparent optical polymer. The material of the coating layer may contain inorganic filler for adjusting the optical characteristics.

Normally, the groove is formed in a circular shape so as to surround the periphery of the lens portion. It should be noted that, however, the groove is not required to be a completely circular shape, as long as the advantages of the present invention can be obtained. For example, the groove may be a partially-divided circular shape.

According to a preferred embodiment of the present invention, a coating layer is formed on the first area and at least part of the groove, and the coating layer is not formed on the second area, in the lens. According to this structure, the lens can be mounted accurately to a device using the second area as a reference surface. In using the second area as a reference surface, the second area may be flat, or may be other shapes that allow easy positioning.

In the lens according to the present invention, the whole of the first area may be a lens portion. Further, the groove surrounding the first area may be adjacent to the lens portion. According to this structure, the thickness uniformity of the coating layer in the peripheral portion of the lens portion especially can be improved.

The lens of the present invention may include a plurality of the first areas. In other words, the lens of the present invention may include a plurality of the lens portions with a convex shape.

### [Method for Manufacturing the Lens]

A method for manufacturing a lens according to the present invention is a method for manufacturing a lens including a lens portion with a convex shape and a coating layer formed on the lens portion. According to this method, the lens of the present invention can be manufactured. The overlapping description already given with regard to the lens of the present invention may be omitted since the description may be applied to the manufacturing method of the present invention. The manufacturing method of the present invention includes the following steps (i) and (ii).

In step (i), a lens base including at least one first area having a lens portion and a second area surrounding the first area is provided. A groove surrounding the first area is formed between the first area and the second area of the lens base. As to the lens base, since a detailed description is given in the first embodiment, the overlapping description is omitted. There is no limitation for the forming method of the lens base. The lens base can be formed by a known method, such as casting, compression molding, or injection molding.

In the next step (ii), the material of a coating layer is placed on the lens portion. The material of the coating layer may be applied entirely to the surface of the lens portion. Further, the material of the coating layer may be applied to part of the lens portion (e.g. the top portion), and then it spreads over the surface of the lens portion downwardly, thereby being applied to the entire surface of the lens portion. The excess material is gathered into the groove. As a result, the formation of the coating layer on the second area can be prevented. According to an example of the present invention, the material of the coating layer is placed on the first area in step (ii). Further, according to another example of the present invention, the coating layer is formed on the first area in step (ii). The material applied on the lens portion may be cured as needed. As a result, a coating layer is formed on the surface of the lens portion.

The material of the coating layer may be selected depending on the coating layer to be formed. The material of the coating layer may be diluted with a solvent depending on the application method of the material of the coating layer.

The method for curing the material of the coating layer may be selected depending on the material of the coating layer. For example, when an ultraviolet curable resin is used, curing is performed by ultraviolet irradiation (UV irradiation). Further, curing may be achieved by heat treatment after eliminating the solvent included in the material of the coating layer.

According to a preferred embodiment of the present invention, a coating layer is formed on the first area and at least part of the groove, and the coating layer is not formed on the second area. Since the coating layer is not formed on the second area, the second area can be used as a reference surface. In a typical example, the coating layer is formed on the whole surface of the lens portion and at least part of the groove, and is not formed on the second area.

In step (ii), the material of the coating layer may be placed on the lens portion by spin coating. Alternatively, in step (ii), the material of the coating layer may be placed on the lens portion by screen printing. Further alternatively, in step (ii), the material of the coating layer may be placed on the lens portion by pad printing. When using screen printing and pad printing, it is possible to place the material on a plurality of the lens portions present in a base by a single printing.

Hereinafter, embodiments of the present invention are described with reference to the drawings.

### FIRST EMBODIMENT

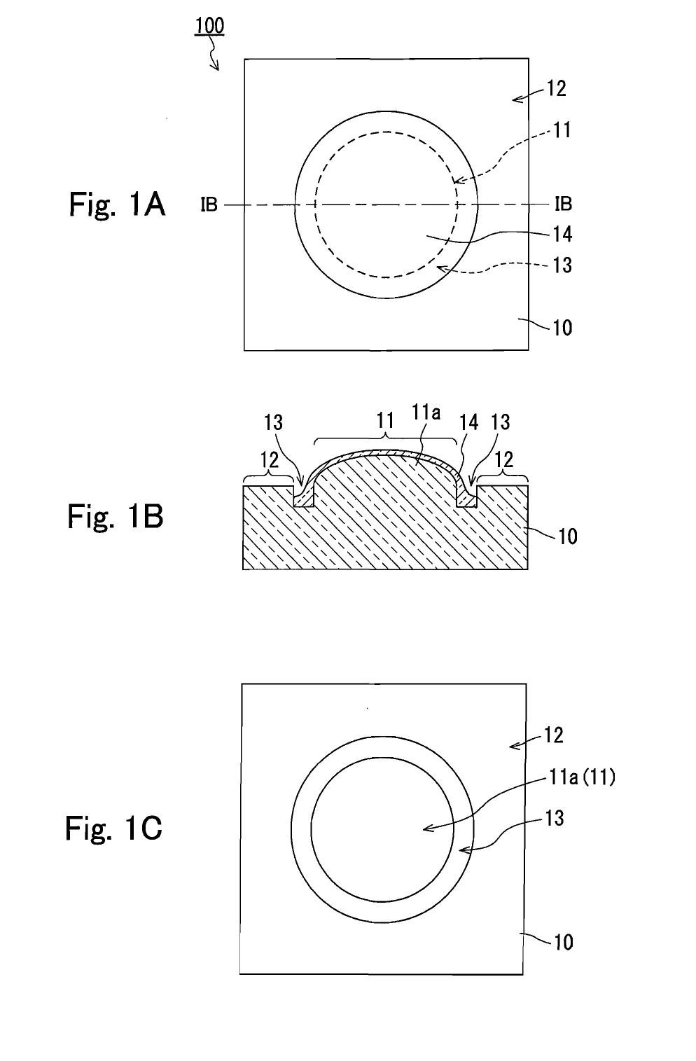

FIG. 1A is a top view of a lens according to a first embodiment, and FIG. 1B is a cross sectional view taken along the line IB-IB in FIG. 1A. A lens 100, as illustrated in FIGS. 1A and 1B, includes a lens base 10 and a coating layer 14 formed on the lens base 10. A top view of the lens base 10 is illustrated in FIG. 1C.

The lens base 10 includes a first area 11 having a lens portion 11a with a convex shape and a second area 12 surrounding the first area 11. In an example of the first embodiment, the whole of the first area 11 is the lens portion 11a. The lens portion 11a is a lens having a circular bottom. The surface shape of the lens portion 11a may be spherical or aspherical.

A groove 13 is formed between the first area 11 and the second area 12. The groove 13 is formed in a circular shape so as to surround the lens portion 11a. The center of the groove 13 viewed in plane and the center of the lens portion 11a viewed in plane are coincident. The coating layer 14 is formed on the whole surface of the lens portion 11a (the first area 11) and part of the groove 13. The coating layer 14 is not formed on the second area 12.

The groove 13 is formed so as to be adjacent to the peripheral edge of the lens portion 11a. According to this structure, the excess material present on the peripheral portion of the lens portion 11a can be received within the groove 13 when forming the coating layer 14. Therefore, the thickness uniformity of the coating layer 14 especially can be improved.

Subsequently, a method for manufacturing the lens 100 is described hereinafter. First, the lens base 10 is formed. The lens base 10 may be formed by a molding process (such as casting, compression molding, or injection molding), a cutting process, or a combination thereof. The groove 13 may be formed by a cutting process or the like, after the first area 11 and the second area 12 are formed. Further, the groove 13 may be formed by integral molding when the first area 11 and the second area 12 are formed.

Next, the coating layer 14 is formed on the surface of the lens portion 11a. As a forming method of the coating layer 14, spin coating, screen printing, pad printing, or the like may be employed. These are low-cost methods with high productivity.

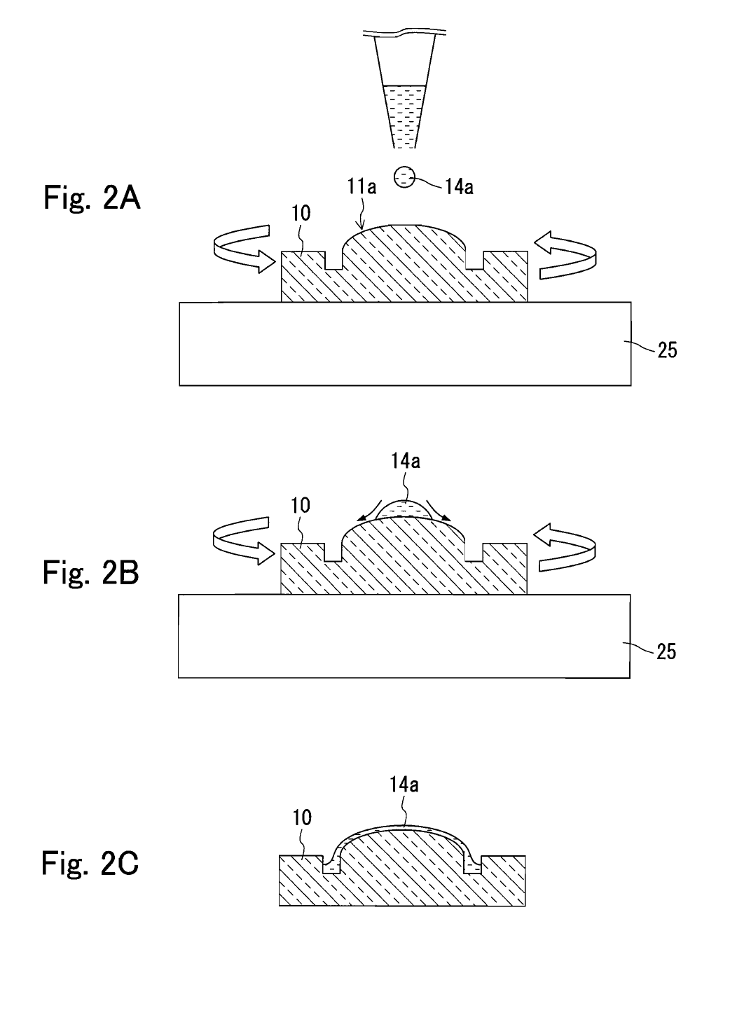

An example of forming the coating layer 14 using spin coating is illustrated in FIGS. 2A to 2C. First, as illustrated in FIG. 2A, the lens base 10 is mounted on the rotation stage 25 so as to be rotated thereon. Then, in a state in which the lens base 10 is rotating, a material 14a of the coating layer 14 is dropped in the center of the lens portion 11a. Alternatively, the material 14a of the coating layer 14 may be dropped in the center of the lens portion 11a, in a state in which the lens base 10 is stationary.

Next, as illustrated in FIG. 2B, rapid rotation of the lens base 10 allows the material 14a to be applied and spread over the surface of the lens portion 11a. As illustrated in FIG. 2C, the excess material 14a is received in the groove 13, and the second area 12 remains uncoated. Finally, the applied material 14a is cured, so that the coating layer 14 is formed.

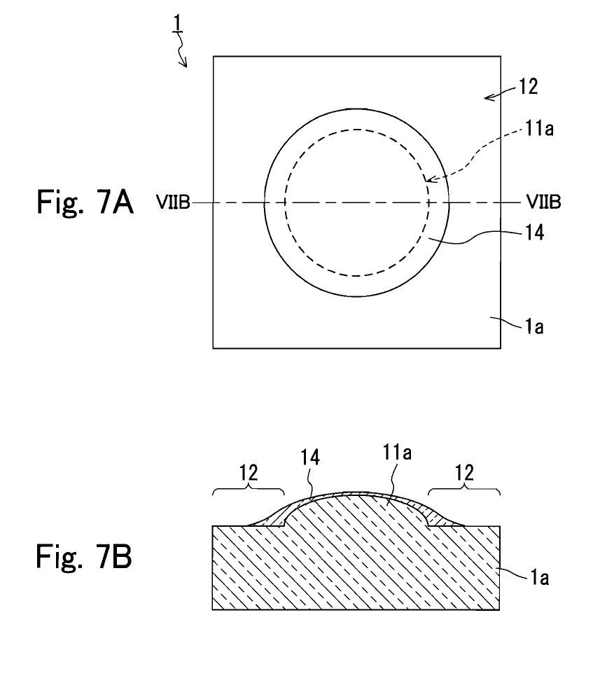

If the groove 13 is not present, as illustrated in FIG. 7B, a phenomenon where an excess material 14a is unevenly distributed in the peripheral portion of the lens portion 11a (hereinafter, which may be referred to as a “pooling phenomenon”) may occur. As a result, the coating layer at the peripheral portion of the lens portion 11a becomes thicker than one at the center of the lens portion 11a. Further, if the groove 13 is not present, the coating layer is formed also on the second area 12 that does not serve as a lens. In contrast, according to the method of the present invention, the groove 13 can prevent pooling phenomena. Furthermore, according to the method of the present invention, the groove 13 can prevent the formation of the coating layer 14 on the second area 12.

When using spin coating to place the material 14a on the lens portion 11a, the material 14a should be applied and spread toward the peripheral edge of the lens portion 11a. Therefore, it is preferable that the viscosity of the material 14a be 0.1 Pa s or less.

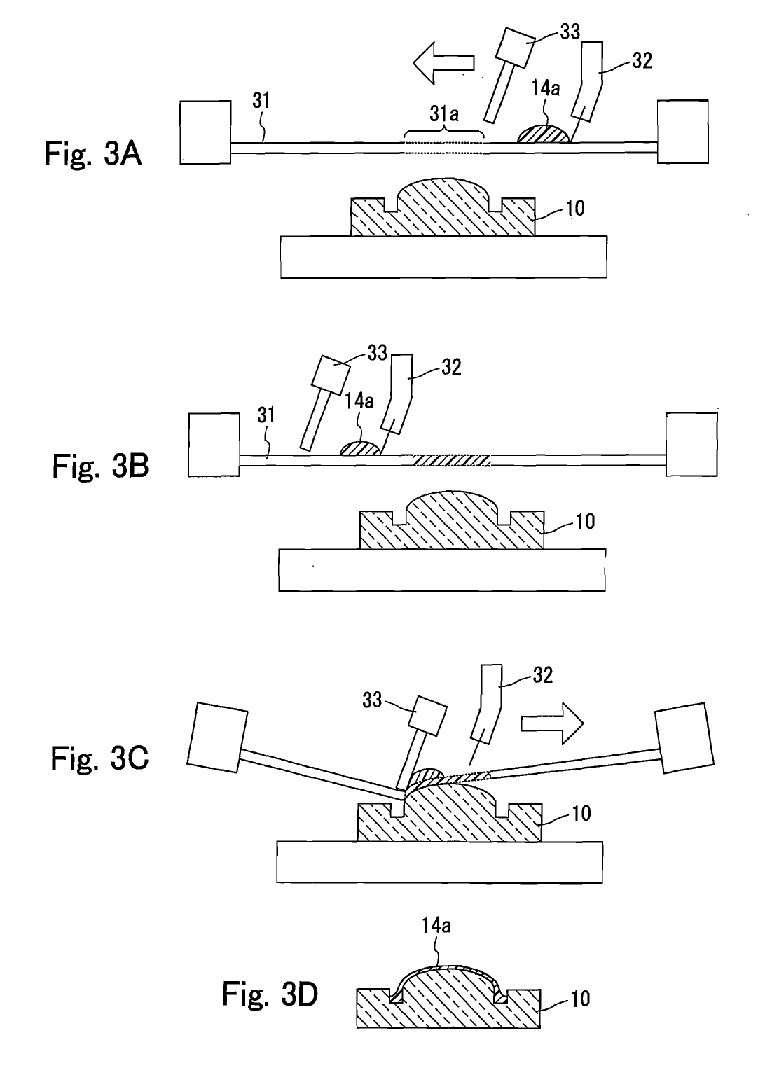

An example of forming the coating layer 14 using screen printing is illustrated in FIGS. 3A to 3D. First, as illustrated in FIG. 3A, a screen plate 31 is provided. The material 14a of the coating layer 14 can penetrate a permeable portion 31a, which corresponds to the lens portion 11a, in the screen plate 31. The material 14a is placed on the screen plate 31.

Next, as illustrated in FIG. 3B the material 14a on the screen plate 31 is moved by means of a scraper 32. Then, as illustrated in FIG. 3C, the material 14a is pressed onto the permeable portion 31a by means of squeegee 33. As a result, part of the material 14a penetrates the permeable portion 31a, and the material 14a is placed on the lens portion 11a, as illustrated in FIG. 3D. Finally, the applied material 14a is cured, so that the coating layer 14 is formed.

Generally, screen printing is used for applying a coating material to a plane member. However, it also can be used, by using a screen plate made of flexible resin, for applying a coating material to a curved surface, such as the lens portion 11a. Further, in screen printing, it is possible to place the material 14a approximately only on the lens portion 11a by using an appropriate screen plate. Therefore, it is possible to reduce the amount of the material 14a applied to areas other than the lens portion 11a by using screen printing.

However, in order to coat the whole of the lens portion 11a with the coating layer 14, the permeable portion 31a needs to be slightly larger than the lens portion 11a. If the groove 13 is not present, as described above, pooling phenomena may occur in the peripheral portion of the lens portion 11a. In contrast, according to the method of the present invention, the groove 13 is formed around the lens portion 11a, so as to be capable of preventing such pooling phenomena. Further, according to the method of the present invention, the second area 12 can be used as a reference surface, because the coating layer can be prevented from being formed on the second area 12.

When placing the material 14a by screen printing, the presence of the groove 13 around the peripheral portion of the lens portion 11a allows the screen plate 31 to contact the peripheral portion of the lens portion 11a easily. Therefore, the thickness uniformity of the coating layer 14 especially can be improved.

When using screen printing to place the material 14a on the lens portion 11a, the material 14a should be moved from the screen plate to the lens portion 11a. Further, after the material 14a is placed on the lens portion 11a, the thickness of the material 14a on the surface of the lens portion 11a needs to be made uniform. Therefore, it is preferable that the viscosity of the material 14a be in the range of 0.1 Pa s to 100 Pa s.

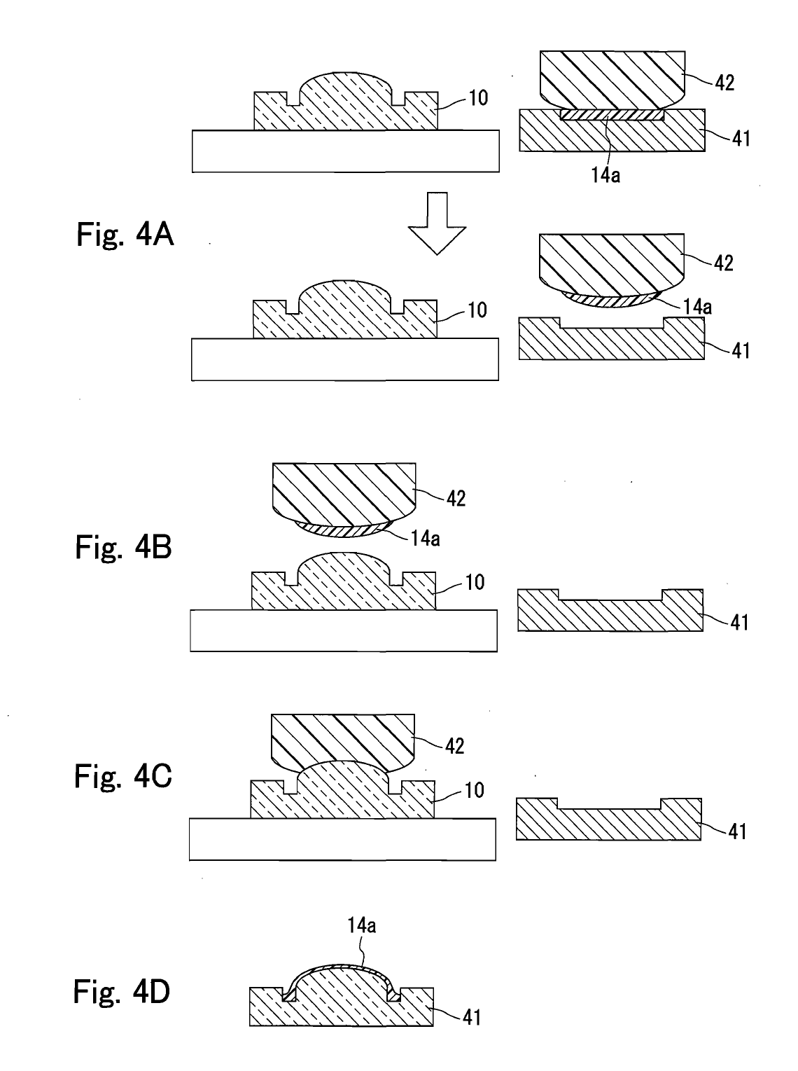

An example of forming the coating layer 14 using pad printing is illustrated in FIGS. 4A to 4D. First, as illustrated in FIG. 4A, a silicone rubber pad 42 is pressed against a printing plate 41 filled with the material 14a, so that the material 14a is attached to the silicone rubber pad 42. Next, as illustrated in FIGS. 4B and 4C, the silicone rubber pad 42 is pressed against the lens portion 11a, so that the material 14a is applied to the lens portion 11a. Thus, as illustrated in FIG. 4D, the material 14a is applied to the lens portion 11a. Finally, the applied material 14a is cured, so that the coating layer 14 is formed.

In pad printing, since a flexible member, such as a silicone rubber pad, is used for printing, a good printing can be achieved even when printing on a curved surface or a meniscus surface. Further, by selecting an appropriate printing plate and an appropriate pad, the material 14a can be applied only to a predetermined portion. However, in order to apply the material 14a to the whole of the lens portion 11a, it is necessary to use the printing plate 41 with a slightly oversized pattern. Therefore, also in pad printing, if the groove 13 is not present, pooling phenomena may occur in the peripheral portion of the lens portion 11a. In contrast, according to the method of the present invention, such pooling phenomena can be prevented, due to the groove 13 formed around the lens portion 11a. Furthermore, the coating layer can be prevented from being formed on the second area 12 due to the groove 13. Accordingly, it is possible to use the second area 12 as a reference surface.

When placing the material 14a by pad printing, the presence of the groove 13 around the peripheral portion of the lens portion 11a allows the pad to contact with the peripheral portion of the lens portion 11a easily. Therefore, the thickness uniformity of the coating layer 14 especially can be improved.

When using pad printing to place the material 14a on the lens portion 11a, the material 14a should be moved from the printing plate to the pad, and then moved from the pad onto the lens portion 11a. Further, after the material 14a is placed on the lens portion 11a, the thickness of the material 14a on the surface of the lens portion 11a needs to be made uniform. Therefore, it is preferable that the viscosity of the material be in the range of 0.1 Pa s to 100 Pa s.

According to the above-described structure, the excess material 14a can be received into the groove 13. Therefore, in the method of the present invention, the shape of the peripheral portion of the lens portion 11a is not required to be different from a desired shape as a lens. Accordingly, the whole of the lens portion 11a can serve effectively as a lens. Further, the coating layer 14 with less variation in thickness can be formed entirely on the lens portion 11a. As a result, a lens having an excellent optical property, such as a lens with reduced optical aberration, can be obtained. Furthermore, the lens 100 can be mounted accurately to a device using the second area 12 as a reference surface, because the coating layer can be prevented from being formed on the second area 12.

### SECOND EMBODIMENT

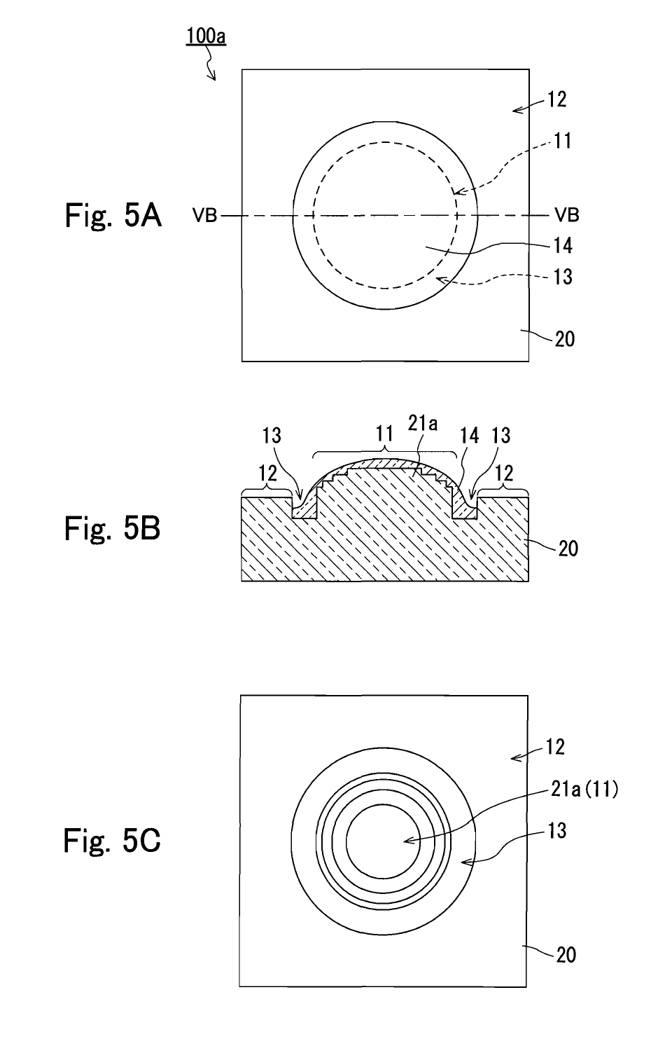

FIG. 5A is a top view of a lens according to a second embodiment, and FIG. 5B is a cross sectional view taken along the line VB-VB in FIG. 5A. A lens 100a illustrated in FIGS. 5A and 5B includes a lens base 20 and a coating layer 14 formed on the lens base 20. A top view of the lens base 20 is illustrated in FIG. 5C.

The lens base 20 includes a first area 11 having a lens portion 21a with a convex shape and a second area 12 surrounding the first area 11. In an example of the second embodiment, the whole of the first area 11 is the lens portion 21a. The lens portion 21a is a diffractive lens. The lens portion 21a is formed by providing unevennesses, a so-called blaze, onto the convex surface of the lens based on a specific spherical coefficient or aspherical coefficient. The lens portion 21a having such a shape is a diffractive lens using diffraction phenomena.

A groove 13 is formed between the first area 11 and the second area 12. The groove 13 is formed in a circular shape so as to surround the lens portion 21a. The center of the groove 13 viewed in plane and the center of the lens portion 21a viewed in plane are coincident. The coating layer 14 is formed on the whole surface of the lens portion 21a (the first area 11) and part of the groove 13. The coating layer 14 is not formed on the second area 12.

The groove 13 is formed so as to be adjacent to the peripheral edge of the lens portion 21a. According to this structure, the excess material present on the peripheral portion of the lens portion 21a can be received within the groove 13 when forming the coating layer 14. Therefore, the thickness uniformity of the coating layer 14 especially can be improved. Further, the coating layer 14 with less variation in thickness can be formed entirely on the surface of the lens portion 21a. As a result, a lens having an excellent optical property, such as a lens with reduced optical aberration, can be obtained. Furthermore, the groove 13 can prevent the formation of the coating layer 14 on the second area 12. Therefore, the lens 100a can be mounted accurately to a device using the second area 12 as a reference surface.

The lens portion 21a, being a diffractive lens, has unevennesses. Therefore, when using spin coating to form the coating layer 14, the material 14a that is placed at the top of the lens portion 21a tends not to flow smoothly downward. In this case, a material 14a diluted with a solvent and having a reduced viscosity can be used. However, a large amount of the material 14a should be applied in order to form the coating layer 14 with a predetermined thickness. If the groove 13 is not present, the material 14a is applied and spread widely over the second area 12, so that the second area 12 cannot be used as a reference surface in mounting. To the contrary, according to the present invention, the groove 13 can prevent the coating layer 14 from being formed on the second area 12. Accordingly, the present invention is especially useful when the lens portion is a diffractive lens. Similarly, the present invention is useful when screen printing or pad printing is employed to form a coating layer on the surface of a diffractive lens.

As a coating layer for a diffractive lens, there has been known a refractive index matching film for correcting chromatic aberration in a camera. A coating layer with a refractive index dispersion that can compensate for the refractive index wavelength dispersion of the material of a lens base is formed on a diffractive lens, and thereby high diffraction efficiency can be achieved over a broad spectral range. Therefore, chromatic aberration can be reduced by installing, in a camera module, a diffractive lens on which a refractive index matching film is formed. Letting n_{L} be the refractive index of a diffractive lens, and n_{P} be the refractive index of a coating layer, the step height d of the blaze whose first-order diffraction efficiency is 100% in the wavelength λ of the lens on which a coating layer is formed is given by:

d=λ/|n_{L}−n_{P}|. [Formula 1]

If the value of the right-hand side of Formula 1 is constant throughout the visible range, the wavelength dependence of diffraction efficiency in the visible range is eliminated.

When a refractive index matching film (which is a coating layer) is formed on a diffractive lens by a method of the present invention, while chromatic aberration can be reduced, optical aberrations caused by variation in the thickness of the coating layer also can be reduced.

### THIRD EMBODIMENT

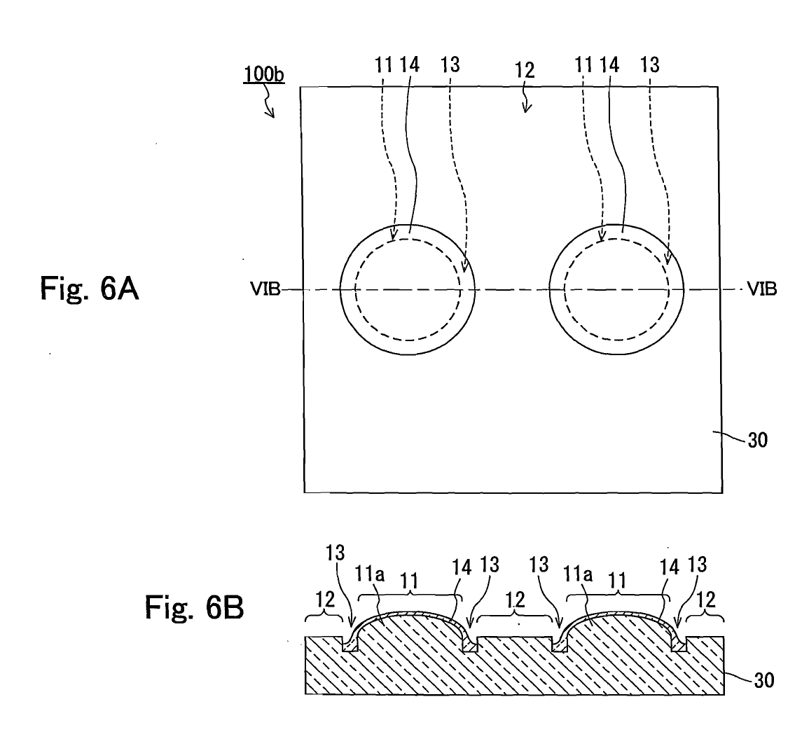

FIG. 6A is a top view of a lens according to a third embodiment, and FIG. 6B is a cross sectional view taken along the line VIB-VIB in FIG. 6A. A lens 100b includes a lens base 30 and a coating layer 14 formed on the lens base 30, as illustrated in FIGS. 6A and 6B.

The lens base 30 includes two first areas 11 each including a lens portion 11a with a convex shape and a second area 12 surrounding the two first areas 11. In an example of the third embodiment, the whole of the first area 11 is the lens portion 11a. A groove 13 is formed between the first area 11 and the second area 12. The coating layer 14 is formed on the whole surfaces of the lens portions 11a and part of the grooves 13. The coating layer 14 is not formed on the second area 12.

The lens 100b includes two lens portions 11a formed on the same surface of a single lens base 30. The lens 100b can serve as a binocular lens. Due to parallax between the two lens portions 11a of the lens 100b, the distance to an object can be measured. In order to increase the accuracy of the distance measurement, it is especially important that there is no unevenness in a reference surface used in mounting the binocular lens to a camera module. If the accuracy of the reference surface is low, tilt occurs between the binocular lens and the image area. This tilt may cause the deterioration in the accuracy of the distance measurement.

The first areas 11 and the grooves 13 each have the same structure as the counterparts in the first embodiment. Accordingly, in the lens 100b, similarly to the lens 100, the whole of the lens portions 11a can be used effectively. Further, since the coating layer 14 is not formed on the second area 12, it is possible to use the second area 12 as a reference surface in mounting the lens 100b to a camera module.

When the coating layer 14 is formed on the lens portion 11a by spin coating, if the grooves 13 are not present, the material 14a of the coating layer 14 is applied and spread widely over the second area 12. As a result, the materials 14a dropped on each lens portion 11a interferes with each other. As a result, it becomes hard to form a coating layer 14 with less thickness variation on each lens portion 11a. On the other hand, in the lens 100b of the third embodiment, the grooves 13 are formed, thereby preventing the materials 14a dropped on each lens portion 11a from interfering. As a result, a coating layer 14 with less thickness variation can be formed on every lens portion 11a. Further, since the coating layer 14 is not formed on the second area, it is possible to use the second area 12 as a reference surface in mounting the lens 100b to a camera module. Therefore, when using the lens 100b for distance measurement, the accuracy of the distance measurement can be secured.

When forming the coating layer 14 on a plurality of lens portions 11a by spin coating, the coating layer 14 is formed by the following process in general. First, material 14a of the coating layer 14 is dropped on a first lens portion 11a, and the lens base 30 is rotated about the center of the first lens portion 11a, so that the material 14a is applied on the first lens portion 11a. Next, material 14a of the coating layer 14 is dropped on a second lens portion 11a, and the lens base 30 is rotated about the center of the second lens portion 11a, so that the material 14a is applied to the second lens portion 11a. Similarly, each lens portion should be spin coated one by one, even when three or more lens portions are formed on a lens base. Due to such a process, the coating layer 14 with less thickness variation can be formed on each of the lens portions 11a.

As described above, the present invention is especially useful when forming a coating layer on each lens portion of a binocular lens.

In the case of the binocular lens, the coating layer may be formed by screen printing or pad printing in the same manner as the first embodiment. The present invention is also effective when screen printing or pad printing is employed.

In the third embodiment, a case where two lens portions are formed on a lens base has been described. However, even in a case where three or more lens portions are formed on a lens base, similar effects can be achieved.

In the third embodiment, there has been described a case where the groove 13 formed for each of the plurality of the lens portions 11a is formed separately. However, the grooves 13 may be connected.

In the third embodiment, a case where every lens portion 11a has the groove 13 formed circumferentially has been described. However, if a plurality of the lens portions include a lens portion, which does not need a coating layer, the groove 13 may not be formed around the lens portion.

In the third embodiment, although a case where the lens portion 11a is aspherical has been described, similar effects can be achieved, even in a case where the shape is spherical, or the lens is a diffractive lens.

In the first to third embodiments, there has been described a case where the groove 13 is formed in a circular shape so as to surround the entire peripheral portion of the lens portion 11a (the first area 11). However, the groove 13 is not always required to be a complete circular shape. Even if the groove 13 is partially discontinuous, the advantageous effects of the present invention can be achieved when the width of the interval is narrow.

In the first to third embodiments, the case where the groove 13 with a rectangular shape in cross section is used has been described. However, the cross section of the groove 13 may be, for example, U-shaped, or V-shaped, instead of a rectangular shape, as long as the advantageous effects of the present invention can be obtained.

In the first to third embodiments, a case where the whole of the first area 11 is a lens portion has been described. However, the first area 11 may include a portion arranged around the lens portion 11a that does not serve as a lens.

In the first to third embodiments, a case where the lens portion is formed only on one surface of a lens base has been described. However, even if the lens portion is formed on both surfaces of a lens base, the advantageous effects of the present invention can be achieved. For example, in a case where an aspherical lens is formed on a main surface of a lens base and a diffractive lens portion is formed on the other main surface, the advantageous effects of the present invention can be obtained.

### EXAMPLE

Hereinafter, a lens and a method for manufacturing the same according to the present invention are described by way of concrete examples. In the following examples, the lens base made of optical polymer was formed by injection molding. Further, the lens base made of glass was formed by compression molding.

### Example 1

In Example 1, an example of manufacturing the lens 100 illustrated in FIGS. 1A and 1B is described. In Example 1, the lens base 10 made of polycarbonate (AD-5503, manufactured by TEIJIN CHEMICALS LTD.) was used.

The planar shape of the lens base 10 was 4 mm square. The lens portion 11a (the first area 11) was arranged in the center of the lens base 10. The diameter of the lens portion 11a was 1.2 mm, and the thickness from the bottom of the lens base 10 to the top of the lens portion 11a was 0.8 mm. The thickness of the second area was 0.6 mm. The width of the groove 13 was 0.2 mm, and the depth of the groove 13 was 0.2 mm.

Next, photopolymerization initiator was mixed with acrylic oligomer (UV-7000B, manufactured by The Nippon Synthetic Chemical Industry Co., Ltd.), then they were diluted with propylene glycol monomethyl ether, and thereby the material 14a of the coating layer 14 was provided. The viscosity of the material 14a was 0.1 Pa s.

Next, the lens base 10 was positioned in a spin-coating apparatus so that the center of the lens portion 11a and the center of rotation in spin coating were coincident. Then, the material 14a was dropped on the top of the lens portion 11a, and spin coating was performed at a rotational velocity of 2,000 rpm for 10 seconds. Subsequently, the pressure was reduced for 10 minutes at room temperature, and thereby the solvent included in the material 14a was volatilized. Finally, the material 14a was cured by UV irradiation. Thus, the lens 100 illustrated in FIGS. 1A and 1B was obtained.

### Comparative Example 1

As a lens 1 of Comparative Example 1, the same lens as the lens 100 was manufactured, except that the groove 13 was not formed therein. The lens 1 manufactured in Comparative Example 1 is illustrated in a top view of FIG. 7A and a cross sectional view of FIG. 7B. The lens base 1a in the lens 1 has the same structure as the lens base 10 of Example 1, except that it does not have the groove 13. The coating layer 14 was formed on the lens portion 11a of the lens base 1a, using the same material and method as Example 1.

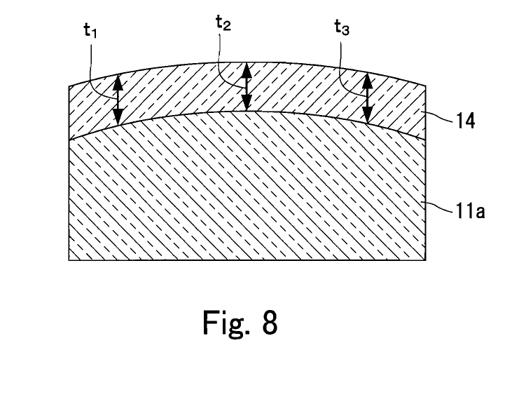

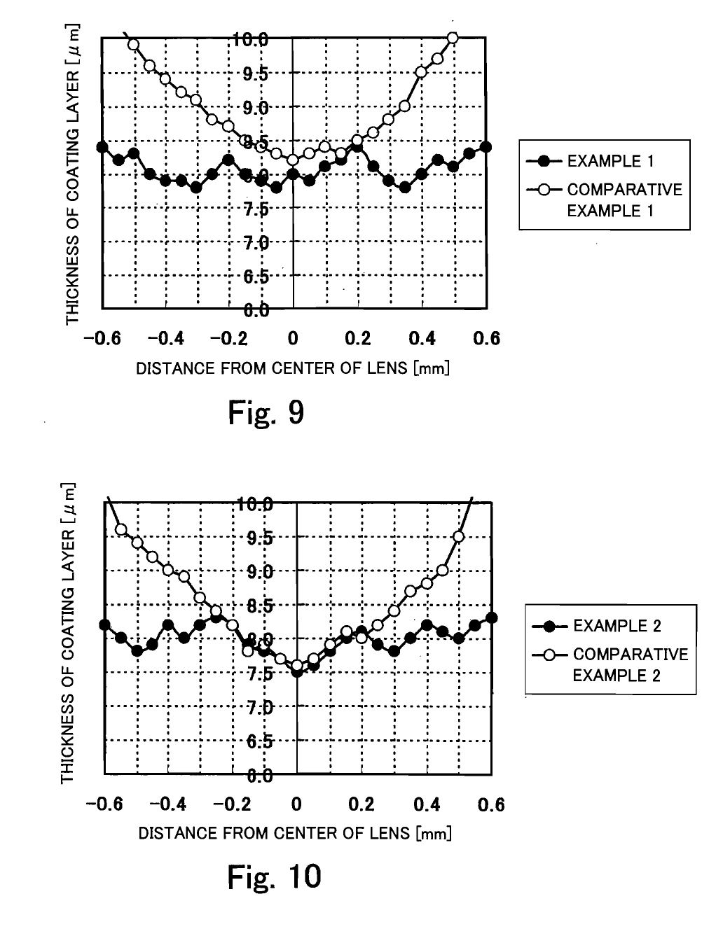

With respect to the lens of Example 1 and the lens of Comparative Example 1, the thickness of the coating layer in the lens portion was measured. The thickness of the coating layer was measured by means of a shape measuring device using laser reflection. More specifically, the shapes before and after formation of the coating layer were measured at an arbitrary cross section. The thicknesses of the coating layer 14 (such as t1, t2, and t3 in FIG. 8) at different distances from the center of the lens were obtained based on the measured value illustrated in FIG. 8. As illustrated in FIG. 8, the thickness in the direction parallel to the optical axis of the lens was measured as the thickness of the coating layer. The result of the measurement is shown in FIG. 9.

In the lens 1 of Comparative Example 1 where the groove 13 was not formed, the thickness of the coating layer 14 had a tendency toward monotonic increase, as the distance from the center of the lens portion 11a increased, as shown in FIG. 9. Especially, the increase rate tended to be higher around the peripheral portion of the lens portion 11a (where the distance from the center of the lens portion 11a is about ±0.6 mm). On the other hand, in the lens 100 of Example 1 where the groove 13 was formed, the thickness of the coating layer 14 was almost constant even at a portion away from the center of the lens portion 11a, and the thickness was made nearly uniform throughout the whole of the lens portion 11a. In other words, in the lens 100, the surface shape of the coating layer 14 and the shape of the aspherical surface of the lens portion 11a were almost coincident.

Subsequently, the cross sections of the lens in Example 1 and the lens in Comparative Example 1 were observed. In the lens 1 of Comparative Example 1, as illustrated in FIG. 7B, pooling phenomena, where the coating layer 14 was thickened, occurred in the peripheral portion of the lens portion 11a. In contrast, in the lens 100 of Example 1, pooling phenomena occurred within the groove 13, as illustrated in FIG. 1B, so that the thickness of the coating layer 14 on the surface of the lens portion 11a was made nearly uniform.

Further, in the lens 1 of Comparative Example 1, the coating layer 14 was formed also on the second area 12, while the coating layer 14 was not formed on the second area 12 in the lens 100 of Example 1.

### Example 2

In Example 2, another example of manufacturing the lens 100 illustrated in FIGS. 1A and 1B is described. In Example 2, the lens base 10 made of optical glass (K-LaKn14, manufactured by SUMITA OPTICAL GLASS, INC.) was used. The coating layer 14 was formed on this lens base 10, using the same material and method as Example 1, so that the lens 100 was obtained.

### Comparative Example 2

As a lens of Comparative Example 2, the same lens as the lens of Example 2 was manufactured, except that the groove 13 was not formed therein.

With respect to the lens of Example 2 and the lens of Comparative Example 2, the thickness of the coating layer was measured. The result of the measurement is shown in FIG. 10. The thickness of the coating layer was obtained by the same method as Example 1. In the lens of Comparative Example 2 where the groove 13 was not formed, the thickness of the coating layer 14 had a tendency toward monotonic increase, as the distance from the center of the lens portion 11a increased, as shown in FIG. 10. On the other hand, in the lens of Example 2 where the groove was formed, the thickness of the coating layer was almost constant even at a portion away from the center of the lens portion 11a, and was made nearly uniform throughout the whole of the lens portion 11a.

Subsequently, the cross sections of the lens in Example 2 and the lens in Comparative Example 2 were observed. In the lens of Comparative Example 2, pooling phenomena occurred in the peripheral portion of the lens portion. In contrast, in the lens of Example 2, pooling phenomena occurred within the groove 13, so that the thickness of the coating layer 14 on the lens portion 11a was made nearly uniform.

Further, in the lens of Comparative Example 2, the coating layer 14 was formed also on the second area 12, while the coating layer 14 was not formed on the second area 12 in the lens of Example 2.

### Example 3

In Example 3, an example of manufacturing the lens 100a illustrated in FIGS. 6A and 5B is described. In Example 3, the lens base 20 made of polycarbonate (AD-5503, having a refractive index at the “D” line of 1.59 and Abbe number of 28, manufactured by TEIJIN CHEMICALS LTD.) was used. The planar shape of the lens base 20 was 4 mm square. The lens portion 21a (the first area 11) was arranged in the center of the lens base 20. The diameter of the lens portion 21a was 1.2 mm, and the thickness from the bottom of the lens base 20 to the top of the lens portion 21a was 0.8 mm. The thickness of the second area 12 was 0.6 mm. The step height of the blaze was 15.5 μm. The width of the groove 13 was 0.2 mm, and the depth of the groove 13 was 0.2 mm.

As the material 14a of the coating layer 14, there was provided a propylene glycol monomethyl ether dispersion (with a total solid content of 75 wt %) of a mixture of acrylic oligomer (having a refractive index at the “D” line of 1.53 and Abbe number of 52) containing an alicyclic hydrocarbon group and zirconium oxide filler. The zirconium oxide filler having the first-order particle size of 3 nm to 10 nm and containing 30 wt % of silane-based surface treatment agent was used. The zirconium oxide filler was added so that its weight ratio in the solid content of the material 14a should be 56 wt %. The viscosity of the material 14a was 0.1 Pa s.

Then, the lens 100a was obtained by spin coating, volatilizing solvent, and irradiating UV in the same manner as Example 1. As a result of the refractive index characterization of the coating layer 14 after curing, a refractive index at the “D” line was 1.62 and Abbe number was 43.

A diffractive lens with low chromatic aberration can be achieved by combining the material of a lens base and the material of a coating layer, and by designing the steps in a blaze appropriately. Further, the function of a lens can be improved by consistency in the surface shape of the coating layer and the aspherical shape obtained by connecting the lower surfaces of the steps of the blaze of a diffractive lens.

### Comparative Example 3

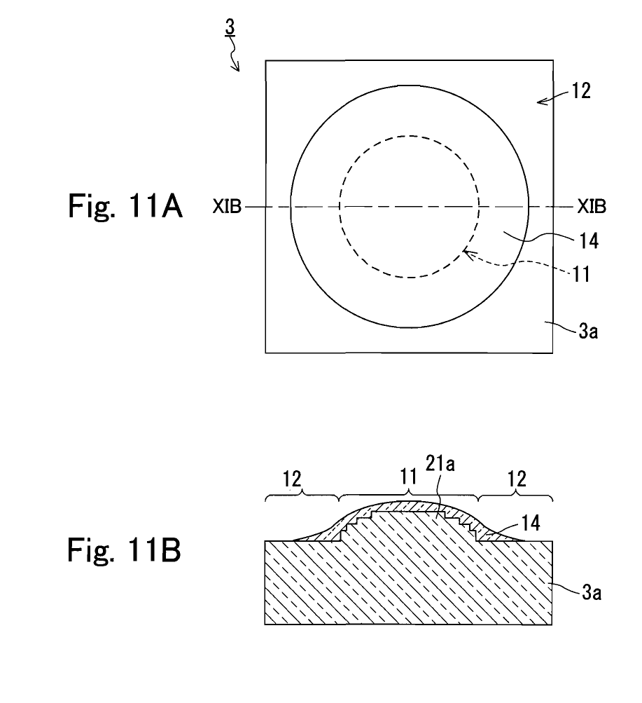

In Comparative Example 3, a lens 3 illustrated in a top view of FIG. 11A and a cross sectional view of FIG. 11B was manufactured. In Comparative Example 3, a lens base 3a was used. The lens base 3a is the same as the lens base 20 of Example 3, except that it does not have the groove 13. The coating layer 14 was formed on the lens base 3a, using the same material and method as Example 3, so that the lens 3 of Comparative Example 3 was obtained.

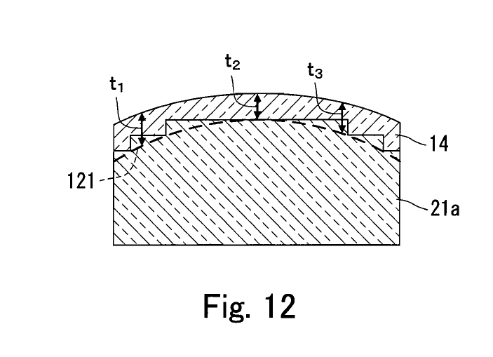

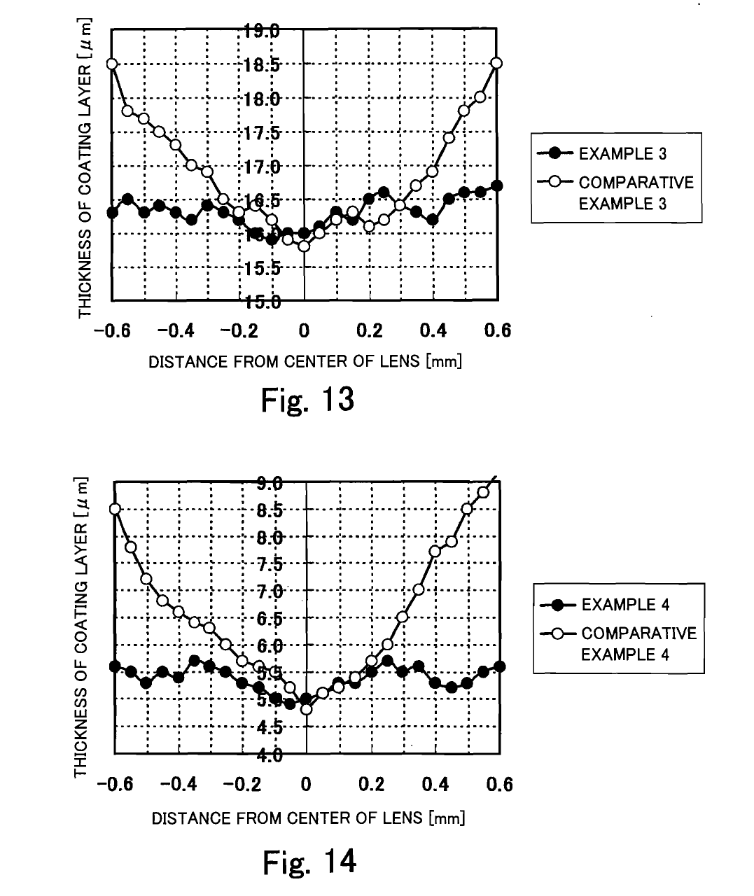

With respect to the lens of Example 3 and the lens of Comparative Example 3, the thickness of the coating layer 14 in the lens portion was measured. More specifically, first, the shapes of surfaces before and after formation of the coating layer were measured at an arbitrary cross section by means of a shape measuring device using laser reflection. Then, an aspherical curve 121 (which is denoted by dashed line in FIG. 12) connecting the lower surfaces of the steps of the blaze was obtained based on the measurement before formation of the coating layer. As illustrated in FIG. 12, the distance from the aspherical curve 121 to the surface of the coating layer 14 was obtained to be the thickness of the coating layer 14. The result of the measurement is shown in FIG. 13.

In the lens of Comparative Example 3 where the groove was not formed, the thickness of the coating layer had a tendency toward monotonic increase, as the distance from the center of the lens portion increased, as shown in FIG. 13. Especially, the increase rate tended to be higher around the peripheral portion of the lens portion (where the distance from the center of the lens portion is about ±0.6 mm). On the other hand, in the lens of Example 3 where the groove was formed, the thickness of the coating layer was almost constant even away from the center of the lens portion, and was made nearly uniform throughout the whole of the lens portion. In other words, in Example 3, the surface shape of the coating layer and the aspherical shape obtained by connecting the lower surfaces of the steps of the blaze of the diffractive lens were almost coincident.

Subsequently, the cross sections of the lens in Example 3 and the lens in Comparative Example 3 were observed. In both lenses of Example 3 and Comparative Example 3, the coating layer had filled in the unevennesses (blazes) of the lens portion without air bubbles. Further, in the lens of Example 3, pooling phenomena of the material of the coating layer were found within the groove 13. In contrast, in the lens of Comparative Example 3, pooling phenomena of the material of the coating layer were found in the peripheral portion of the lens portion. Further, in the lens of Comparative Example 3, the coating layer was formed on the second area, while the coating layer was not formed on the second area in the lens of Example 3.

### Example 4

In Example 4, another example of manufacturing the lens 100a illustrated in FIGS. 5A and 5B is described. In Example 4, the lens base 20 made of optical glass (K-LaKn14, having a refractive index at the “D” line of 1.74 and Abbe number of 53, manufactured by SUMITA OPTICAL GLASS, INC.) was used. The planar shape of the lens base 20 was 4 mm square. The diameter of the lens portion 21a was 1.2 mm, and the thickness from the bottom of the lens base to the top of the lens portion 21a was 0.8 mm. The thickness of the second area 12 was 0.6 mm. The step height of the blaze was 4.7 μm. The width of the groove 13 was 0.2 mm, and the depth of the groove 13 was 0.2 mm.

As a material of the coating layer, there was provided a methylethylketone solution (with a total solid content of 40 wt %) of a epoxy oligomer (OPTMER KRX, having a refractive index at the “D” line of 1.62 and Abbe number of 24, manufactured by Asahi Denka Co., Ltd.). Then, in the same manner as Example 3, the lens 100a was obtained by spin coating, volatilizing solvent, and irradiating UV. In this case, as well as Example 3, a diffractive lens with low chromatic aberration can be achieved by combining the material of a lens base and the material of a coating layer, and by setting the steps in blaze appropriately. Further, the function of a lens can be improved by consistency in the surface shape of the coating layer and the aspherical shape obtained by connecting the lower surfaces of the steps of the blaze of a diffractive lens.

### Comparative Example 4

In Comparative Example 4, a lens was manufactured using the same material and method as the lens 100a of Example 4, except that the groove 13 is not present on the lens base.

With respect to the lens of Example 4 and the lens of Comparative Example 4, the thickness of the coating layer of the lens portion was measured. The result of the measurement is shown in FIG. 14. The thickness of the coating layer was obtained by the same method as Example 3.

As shown in FIG. 14, in the lens of Comparative Example 4 where the groove was not formed, the thickness of the coating layer had a tendency toward monotonic increase, as the distance from the center of the lens portion increased. On the other hand, in the lens of Example 4 where the groove was formed, the thickness of the coating layer was almost constant even away from the center of the lens portion, and was made nearly uniform throughout the whole of the lens portion. In other words, the surface shape of the coating layer and the aspherical shape obtained by connecting the lower surfaces of the steps of the blaze of the diffractive lens were almost coincident.

Subsequently, the cross sections of the lens in Example 4 and the lens in Comparative Example 4 were observed. In the lens of Example 4, pooling phenomena of the material of the coating layer were found within the groove 13. In contrast, in the lens of Comparative Example 4, pooling phenomena of the material of the coating layer were found in the peripheral portion of the lens portion. Further, in the lens of Comparative Example 4, the coating layer was formed on the second area, while the coating layer was not formed on the second area in the lens of Example 4.

### Example 5

In Example 5, an example of manufacturing the lens 100b illustrated in FIGS. 6A and 6B is described. In Example 5, the lens base 30 made of polycarbonate (AD-5503, manufactured by TEIJIN CHEMICALS LTD.) was used.

The planar shape of the lens base 30 was 5 mm square. The lens portion 11a (the first area 11) was arranged approximately in the center of the lens base 30. The diameter of the lens portion 11a was 1.2 mm. The thickness from the bottom of the lens base 30 to the top of the lens portion 11a was 0.8 mm. The thickness of the second area was 0.6 mm. The width of the groove 13 was 0.2 mm, and the depth of the groove 13 was 0.2 mm. The distance between the two lens portions 11a was 1.0 mm.

The same solution as Example 1 was provided as a material 14a of the coating layer. Next, the lens base 30 was positioned in a spin-coating apparatus so that the center of one lens portion 11a and the center of rotation in spin coating were coincident. Then, the material 14a was dropped on the top of the one lens portion 11a, and spin coating was performed at a rotational velocity of 2,000 rpm for 10 seconds. Next, the lens base 30 was positioned in a spin-coating apparatus so that the center of the other lens portion 11a and the center of rotation in spin coating were coincident. Then, the material 14a was dropped on the other lens portion 11a, and spin coating was performed at a rotational velocity of 2,000 rpm for 10 seconds. Subsequently, the pressure was reduced for 10 minutes at room temperature, and thereby the solvent included in the material 14a was volatilized. Finally, the material 14a was cured by UV irradiation. Thus, the lens of Example 5 was obtained.

### Comparative Example 5

In Comparative Example 5, a lens was manufactured using the same material and method as the lens 100b of Example 5, except that the groove 13 is not present on the lens base.

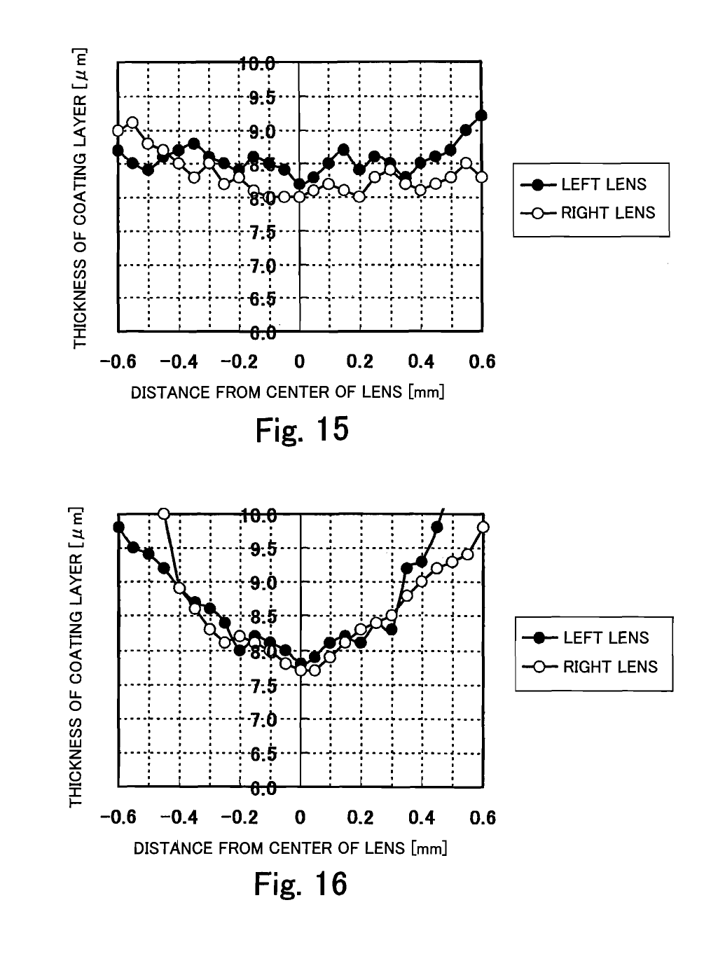

With respect to the lens of Example 5 and the lens of Comparative Example 5, the thickness of the coating layer on the lens portion was measured. The thickness was measured by the same method as Example 1 on the line joining each center of the two lens portion. The measurement result of the lens of Example 5 is shown in FIG. 15, and the measurement result of the lens of Comparative Example 5 is shown in FIG. 16.

As shown in FIG. 16, in the lens of Comparative Example 5 where the groove 13 was not formed, the thickness of the coating layer had a tendency toward monotonic increase, as the distance from the center of the lens portion increased. Especially, the variation of the thickness increased in a portion near the adjacent lens portion.

On the other hand, in the lens of Example 5 where the groove 13 was formed, the thickness of the coating layer was almost constant even away from the center of the lens portion, and the thickness was made nearly uniform throughout the whole of the lens portion, as shown in FIG. 15. Further, also in the portion near the adjacent lens portion, the variation of the thickness of the coating layer was prevented, compared to the lens of Comparative Example 5. Furthermore, in the lens of Comparative Example 5, the coating layer was formed on the second area, while the coating layer was not formed on the second area in the lens of Example 5.

### Example 6

In Example 6, a lens base on which two diffractive lenses are formed was manufactured.

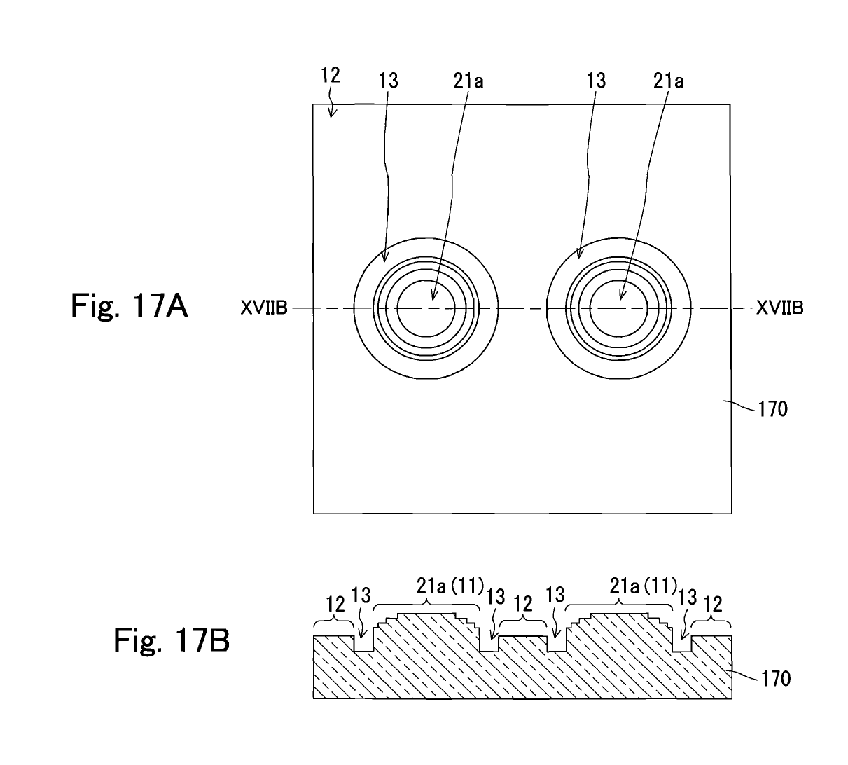

First, a lens base 170 made of polycarbonate (AD-5503, having a refractive index at the “D” line of 1.59 and Abbe number of 28, manufactured by TEIJIN CHEMICALS LTD.) was provided, as illustrated in the top view of FIG. 17A and the cross sectional view of FIG. 17B. The lens base 170 includes two lens portions 21a arranged on the same plane. The lens portion 21a is a diffractive lens. In the lens of Example 6, the whole of the first area 11 each is a lens portion 21a. The lens base 170 includes two first areas 11, and the second area 12 arranged in the periphery thereof. A groove 13 is formed between the first area 11 and the second area 12.

The planar shape of the lens base 170 was 5 mm square. The shapes of the lens portions 21a and the grooves 13 were the same as the shapes of the lens portions and the grooves in the lens of Example 3. The distance between the two lens portions 21a was 1.0 mm. The coating layer was formed on the lens base 170, using the same material and method as Example 3, so that the lens of Example 6 was obtained.

### Comparative Example 6

In Comparative Example 6, a lens was manufactured using the same material and method as the lens of Example 6, except that the groove 13 is not present on the lens base.

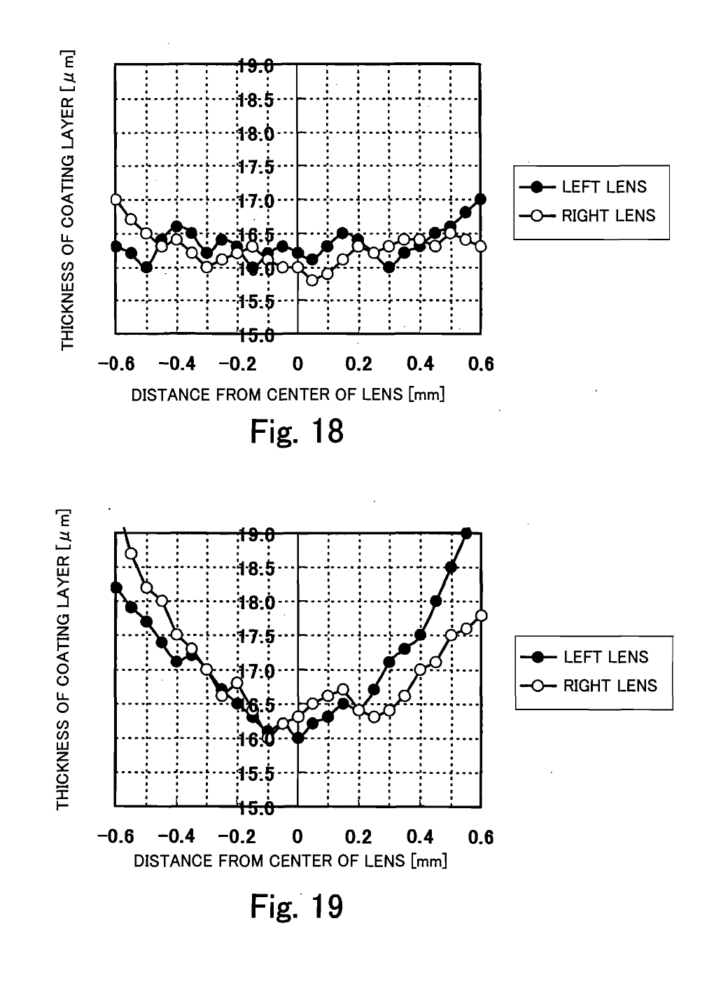

With respect to the lens of Example 6 and the lens of Comparative Example 6, the thickness of the coating layer in the lens portion was measured. The measurement of the thickness was performed by the same method as Example 3 on the line joining each center of the two-lens portion. The measurement result of the lens of Example 6 is shown in FIG. 18, and the measurement result of the lens of Comparative Example 6 is shown in FIG. 19.

As shown in FIG. 19, in the lens of Comparative Example 6 where the groove 13 was not formed, the thickness of the coating layer had a tendency toward monotonic increase, as the distance from the center of the lens portion increased. Especially, the variation of the thickness increased in a portion near the adjacent lens portion.

On the other hand, in the lens of Example 6 where the groove 13 was formed, the thickness of the coating layer was almost constant even away from the center of the lens portion, and was made nearly uniform throughout the whole of the lens portion, as shown in FIG. 18. Further, the variation of the thickness of the coating layer in Example 6 was prevented in the portion near the adjacent lens portion, compared to the lens of Comparative Example 6. Further, in the lens of Comparative Example 6, the coating layer was formed on the second area, while the coating layer was not formed on the second area in the lens of Example 6.

### Example 7

In Example 7, an example of manufacturing the lens 100a illustrated in FIGS. 5A and 5B by screen printing is described.

In Example 7, the lens base used in Example 3 was used as a lens base. Further, a coating liquid having the same composition as the material of the coating layer in Example 3 and having a difference only in viscosity was used for the material of the coating layer. More specifically, in Example 7, the viscosity of the material of the coating layer was 5 Pa s.

Next, the material of the coating layer was applied to the lens portion by screen printing. For the screen plate, a screen plate made of Tetron, with 20 μm emulsion thickness, provided with a permeable portion of 1.5 mm diameter was used. Next, the pressure was reduced for 10 minutes at room temperature, and thereby the solvent included in the material of the coating layer was volatilized. Subsequently, the material of the coating layer was cured by UV irradiation. The lens of Example 7 was obtained by twice repeating the above described process, i.e., screen printing, volatilizing and irradiating UV.

### Comparative Example 7

In Comparative Example 7, a lens was manufactured using the same material and method as the lens of Example 7, except that the groove 13 is not present on the lens base.

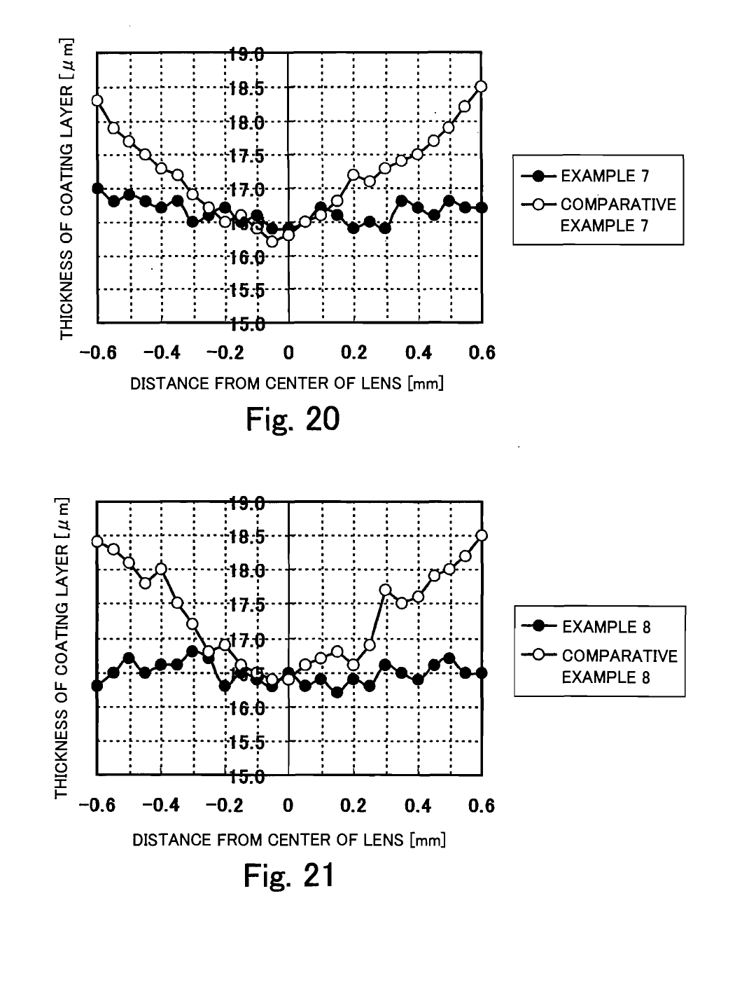

With respect to the lens of Example 7 and the lens of Comparative Example 7, the thickness of the coating layer on the lens portion was measured. The measurement of the thickness was performed by the same method as Example 3. The measurement result is shown in FIG. 20.

As shown in FIG. 20, in the lens of Comparative Example 7 where the groove 13 was not formed, the thickness of the coating layer had a tendency toward monotonic increase, as the distance from the center of the lens portion increased. On the other hand, in the lens of Example 7 where the groove 13 was formed, the variation of the thickness of the coating layer was prevented.

Further, the coating layer was formed on the second area in the lens of Comparative Example 7. This can be because the material of the coating layer applied to the lens portion dropped down to the second area. In contrast, the coating layer was not formed on the second area in the lens of Example 7.

### Example 8

In Example 8, an example of manufacturing the lens 100a illustrated in FIGS. 5A and 5B by pad printing is described.

In Example 8, the lens base used in Example 7 was used as a lens base. The same material of the coating layer as Example 1 was provided as a material of the coating layer. Next, a steel plate having a concave portion of 25 μm in depth, and 1.5 mm in diameter was provided as a printing plate. The material of the coating layer placed in the concave portion of the steel plate was applied to the lens portion by pad printing. Next, the pressure was reduced for 10 minutes at room temperature, and thereby the solvent included in the material of the coating layer was volatilized. Subsequently, the material of the coating layer was cured by UV irradiation. The lens of Example 8 was obtained by three times repeating the above-described process, i.e., pad printing, volatilizing, and irradiating UV.

### Comparative Example 8

In Comparative Example 8, a lens was manufactured using the same material and method as the lens of Example 8, except that the groove 13 is not present on the lens base.

With respect to the lens of Example 8 and the lens of Comparative Example 8, the thickness of the coating layer on the lens portion was measured. The measurement of the thickness was performed by the same method as Example 3. The measurement result is shown in FIG. 21.

As shown in FIG. 21, in the lens of Comparative Example 8 where the groove 13 was not formed, the thickness of the coating layer had a tendency toward monotonic increase, as the distance from the center of the lens portion increased. On the other hand, in the lens of Example 8 where the groove 13 was formed, the variation of the thickness of the coating layer was prevented.

Further, the coating layer was formed on the second area in the lens of Comparative Example 8. This can be because the material of the coating layer applied to the lens portion dropped down to the second area. In contrast, the coating layer was not formed on the second area in the lens of Example 8.

In Examples 1 to 8, the groove 13 having the same shape was employed. However, the shape of the groove 13 is not limited to the above-described shape, as long as it does not deteriorate the optical property. The shape of the groove 13 can be determined in consideration of the material properties of the coating layer (which are mainly, viscosity and surface tension) and the application amount of the material of the coating layer.

Further, in Examples 1 to 8, a coating material including a solvent was used as a material of the coating layer. However, the material of the coating layer may not include a solvent as long as its viscosity is appropriate for the application method employed therein. In such a case, the advantageous effects of the present invention can be achieved.

### INDUSTRIAL APPLICABILITY

The lens according to the present invention is useful in a variety of optical devices or electronics that include a lens. For example, lens according to the present invention may be used in a camera module mounted in mobile phones or vehicles.

1. A lens comprising:
at least one first area including a lens portion with a convex shape; and
a second area surrounding the first area, wherein
a groove surrounding the first area is formed between the first area and the second area,
a coating layer is formed on the first area,
the coating layer is also formed on at least part of the groove, and
the coating layer is not formed on the second area.

2. (canceled)

3. The lens according to claim 1, wherein
the whole of the first area is the lens portion.

4. The lens according to claim 3, wherein
the groove is adjacent to the lens portion.

5. The lens according to claim 1, wherein
the lens portion is a diffractive lens.

6. The lens according to claim 1, comprising
a plurality of the first areas.

7. A method for manufacturing a lens including a lens portion with a convex shape and a coating layer formed on the lens portion, the method comprising the steps of:
(i) providing a lens base including at least one first area including the lens portion and a second area surrounding the first area; and
(ii) placing a material of the coating layer on the lens portion, wherein
a groove surrounding the first area is formed between the first area and the second area in the lens base, and
in the step (ii), the material of the coating layer is placed on the lens portion so that the coating layer is formed on the first area,
the coating layer is also formed on at least part of the groove, and
the coating layer is not formed on the second area.

8. (canceled)

9. The method according to claim 7, wherein
the whole of the first area is the lens portion.

10. The method according to claim 9, wherein
the groove is adjacent to the lens portion.

11. The method according to claim 7, wherein,
in the step (ii), the material of the coating layer is placed on the lens portion by spin coating.

12. The method according to claim 7, wherein,
in the step (ii), the material of the coating layer is placed on the lens portion by screen printing.

13. The method according to claim 7, wherein,
in the step (ii), the material of the coating layer is placed on the lens portion by pad printing.
